(19) United States
(12) Patent Application Publication
(10) Pub. No.: US 2020/0216017 A1
(43) Pub. Date: Jul. 9, 2020

(54) STOLEN VEHICLE RECOVERY SYSTEM

(71) Applicant: GM Global Technology Operations LLC, Detroit, MI (US)

(72) Inventors: Andrew Wassef, Rochester, MI (US); Alyssa L. Scheske, Ann Arbor, MI (US); Tessa E. Elwart, Ann Arbor, MI (US)

(21) Appl. No.: 16/238,775

(22) Filed: Jan. 3, 2019

(51) Int. Cl. B60R 25/04; G08G 1/00; G07C 5/00

(52) U.S. Cl. CPC B60R 25/04; B60R 2025/0415; G07C 5/008; G08G 1/205

(57) ABSTRACT

A method of controlling a vehicle includes receiving a report indicating a vehicle is stolen, determining a vehicle location, providing the vehicle location to a law enforcement provider, and generating a slowdown path for the vehicle. The method further includes querying the law enforcement provider for a confirmation of the vehicle location and an identification of the vehicle, querying the law enforcement provider if the slowdown path is safe and when to initiate slowdown, and forwarding the slowdown path to the vehicle. A system for controlling a vehicle includes a service provider and a central processor provided in the vehicle.

### INTRODUCTION

The present disclosure relates to a system and method for vehicle control and in aspects, a stolen vehicle recovery system and method, which allow for control of the vehicle path and speed.

Stolen vehicle slowdown systems have been developed to take advantage of the advanced driver assistance systems (ADAS) made available to enhance driver safety. Such advanced driver assistance systems include, for example, cruise control, anti-lock braking, and navigation systems. In addition to the development of these systems is the development of in-vehicle communication systems, which provide remote diagnostics, navigation, in-vehicle security, emergency services, and stolen vehicle tracking. Using the communication systems in combination with systems that control vehicle throttle, it has been possible to cut the throttle and slow a vehicle down if it is determined that the vehicle has been stolen or if the vehicle, or its occupants, have been involved in nefarious activity. With the advancement towards automated driving, further development has now been made in advanced driver assistance systems including, e.g., lane centering, cross-wind stabilization, and lane departure warning.

Thus, while current stolen vehicle slowdown systems achieve their intended purpose, there is a need for a new and improved system and method for not only slowing a vehicle down, but also guiding a vehicle to a location.

### SUMMARY

According to several aspects, a method of controlling a vehicle includes receiving a report indicating a vehicle is stolen, determining a vehicle location, providing the vehicle location to a law enforcement provider, and generating a slowdown path for the vehicle. The method further includes querying the law enforcement provider for a confirmation of the vehicle location and an identification of the vehicle, querying the law enforcement provider if the slowdown path is safe and when to initiate slowdown, and forwarding the slowdown path to the vehicle.

In another aspect of the present disclosure, the method further includes overriding control of steering, acceleration, and braking by a driver of the vehicle and configuring the vehicle to slowdown in accordance with the slowdown path.

In another aspect of the present disclosure, the method further includes slowing the vehicle down in accordance with the vehicle slowdown path.

In another aspect of the present disclosure, the method further includes querying the law enforcement provider whether the vehicle is considered stolen prior to determining vehicle location.

In another aspect of the present disclosure, the method further includes receiving a confirmation from law enforcement that vehicle is considered stolen.

In another aspect of the present disclosure, vehicle location is determined based on GPS location data.

In another aspect of the present disclosure, querying the law enforcement provider for the confirmation of vehicle location further includes receiving a notification of visual confirmation of vehicle location.

In another aspect of the present disclosure, querying the law enforcement provider for the identification of the vehicle further includes receiving a notification of visual confirmation of vehicle identification information.

In another aspect of the present disclosure, generating the slowdown path for the vehicle includes using maps and vehicle sensor data.

In another aspect of the present disclosure, generating the slowdown path for the vehicle includes using traffic data.

In another aspect of the present disclosure, the method further includes adjusting the slowdown path for the vehicle based on an instruction from the law enforcement provider.

In another aspect of the present disclosure, the method further includes querying the law enforcement provider for verification of vehicle slowdown.

In another aspect of the present disclosure, vehicle slowdown includes stopping the vehicle.

In another aspect of the present disclosure, the reporting of the vehicle being stolen is received from an owner of the vehicle.

According to several aspects, a method of controlling a vehicle includes receiving a request to slowdown a vehicle, determining a location of the vehicle, providing the location to a law enforcement provider, generating a slowdown path for the vehicle, and receiving a confirmation of the vehicle location and an identification of the vehicle by the law-enforcement provider. The method further includes receiving a confirmation of the safety of the slowdown path by the law enforcement provider, receiving a request from the law enforcement provider for slowdown, and forwarding the slowdown path to vehicle.

In another aspect of the present disclosure, the method includes generating the slowdown path for the vehicle includes determining if the location the vehicle is in is safe to slowdown the vehicle or if the vehicle is approaching a location where it is safe to slowdown the vehicle.

In another aspect of the present disclosure, the method further includes forwarding commands overriding control of the vehicle by a driver and controlling the vehicle through the slowdown path.

In another aspect of the present disclosure, generating the slowdown path includes generating slowdown path inputs including acceleration commands, braking commands, and steering commands. Forwarding the slowdown path to the vehicle includes forwarding the slowdown path inputs to the vehicle. Overriding the driver includes substituting the driver inputs received by at least one of the following: an electronic steering module, a propulsion control module, and an electronic braking module with the slowdown path inputs.

According to several aspects, a system for controlling a vehicle includes a service provider configured to identify a location of a vehicle, generate slowdown path inputs to realize a slowdown path, and transmit the slowdown path inputs to a vehicle, wherein the slowdown path inputs include acceleration commands, braking commands, and steering commands. The system further includes a central processor provided in the vehicle, wherein the central processor is coupled to a communication module, a propulsion control module, an electronic steering module, and an electronic braking module, the central processor configured to receive the slowdown path inputs from the service provider through the communication module, and override driver inputs received by at least one of the following: the electronic steering module, the propulsion control module, and the electronic braking module with the slowdown path inputs upon receipt of a command to slowdown the vehicle.

In another aspect of the present disclosure, the system further includes a law enforcement provider, wherein the service provider is configured to query the law enforcement provider of at least one of the following: i) a confirmation of the location of the vehicle; ii) a confirmation of the slowdown path safety; and iii) a confirmation of slowdown path realization.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic of a system for vehicle control and recovery according to an exemplary embodiment;

FIG. 2a is a flow diagram of a method for vehicle control and recovery according to an exemplary embodiment; and

FIG. 2b is the remainder of the flow diagram of the method illustrated in FIG. 2a beginning at point “A”.

### DETAILED DESCRIPTION

The following description is merely exemplary in nature and is not intended to limit the present disclosure, application, or uses.

The present disclosure is directed to methods and systems for vehicle control and in aspects, stolen vehicle recovery systems and methods, which allow for control of the vehicle path and speed along a vehicle slowdown path. In a number of aspects, a service provider receives a report of a stolen vehicle. The service provider initiates attempts to locate the vehicle. Once the vehicle is located, law enforcement providers may be notified and a slowdown path generated. Upon visual confirmation from a law enforcement provider of vehicle location, additional identification information, and safety conditions, the slow down path may be communicated to the vehicle. In further aspects, the system and method overrides driver control of steering, acceleration and braking.

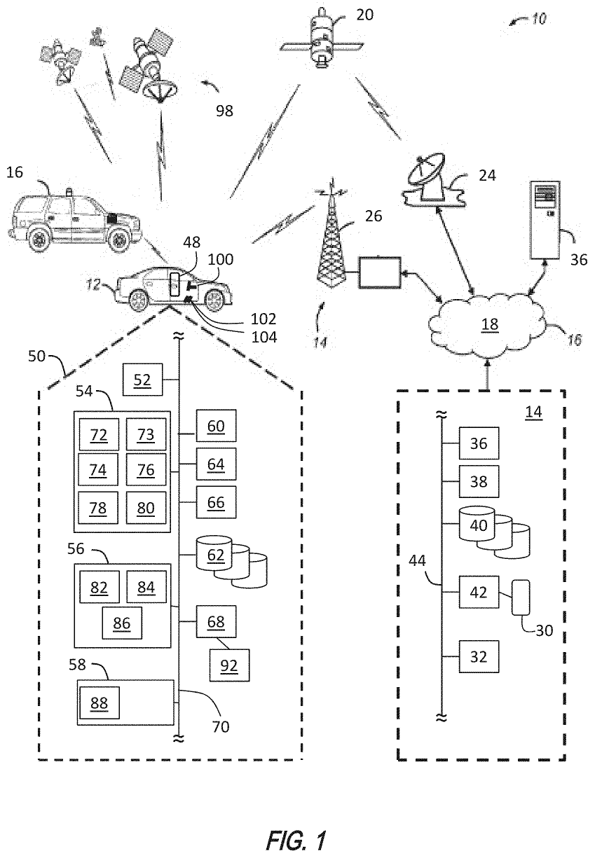

FIG. 1 illustrates, in multiple aspects, a system 10 for vehicle control, which includes a vehicle 12 and a service provider 14. A service provider 14 may be understood as an entity that has authorization from a subscriber 34 to communicate with the vehicle 12, including retrieving information from the vehicle 12 and providing instructions to the vehicle 12. In aspects, the system 10 also includes a law enforcement provider 16. A law enforcement provider 16 may be understood as local, regional/county, state, or federal law enforcement provider or contractors, such as one or more police officers, sheriffs, rangers, military personnel, etc., who are duly authorized to perform duties attendant to the enforcement of the law by local, regional/county, state, or federal government.

The vehicle 12 and service provider 14 are configured to communicate with each other using local area networks 18 and various combinations of wireless communication networks, including but not limited to, satellites 20 (including GPS satellites 98 noted herein) connected to local area networks 18 via uplink stations 24, cell towers 26 by way of the various protocols including code-division multiple access (CDMA) protocols, global system for mobile communication (GSM) protocols, 4G, universal mobile telecommunications systems (UMTS) protocols, long term evolution (LTE) protocols, and 5G as well as international mobile telecommunications protocols published by the International Telecommunication Union; wireless local area networking under the Institute of Electrical and Electronics Engineers (IEEE) 802.11 (Wi-Fi) and short-wavelength UHF radio in the industrial, scientific and medical (ISM) radio bands from 2.400 to 2.485 GHz (Bluetooth). The service provider 14, vehicle 12, or both, communicate with law enforcement provider 16 using local area networks 18 and various combinations of wireless communication noted herein.

In aspects, the service provider 14 includes one or more live advisors 30 or automated voice response systems 32 for interacting with a subscriber 34 facilitated by one or more switches 36, one or more servers 38, databases 40, and one or more processors 42. The subscriber 34 is understood herein as a person/entity having a claim to the vehicle 12, such as an owner, a lessee, a lessor, or an insurer. The switches 36 may route incoming signals so that voice calls are directed to the live advisor 30 or to the voice response systems 32. Data is transmitted to the servers 38, databases 40, or processors 42. In aspects, servers/databases 40 store subscriber 34 account information including vehicle identification information such as color, make, model, or VIN number, vehicle communication information such as the phone number associated with the vehicle, behavior patterns, etc. In additional aspects, servers 38 and databases 40 store map data including geographic information such as drivable surfaces, lanes of travel, topography, waterbodies, and other regional data, such as locations of law enforcement provider offices, road shoulders, parking areas, weigh stations, speed limits, landmarks, etc.

Other than the live advisor 30, the various components of the service provider 14 are connected or connectable by a communication link 44, such as a computer bus or wireless components (Wi-Fi, Bluetooth, etc.). In aspects, the processors 42 perform distributed or parallel processing protocols and the processors 42 may include, for example, application specific integrated circuits, a programmable gate array including a field programmable gate array, a graphics processing unit, a physics processing unit, a digital signal processor, or a front-end processor. The processors 42 are understood to be preprogrammed to execute code or instructions to perform, for example, operations, acts, tasks, functions, or steps, coordinating with other devices and components to perform the operations when needed.

In a number of aspects, the vehicle 12 includes, but is not limited to, passenger or commercial cars and trucks. In aspects, the vehicle is a fuel powered vehicle (such as gasoline, diesel, kerosene or hydrogen powered vehicles), an electric powered vehicle, or a hybrid (fuel and electric) powered vehicle. The vehicle 12 is operable by a driver 48. In aspects, the vehicle 12 includes, for example, an electronic control system 50, which includes a central processor 52, a communication module 54, a propulsion control module 56, an electronic steering module 58, an electronic braking module 60, non-transient data storage 62, a fuel injection control module 64 and a navigation system 66. The components of the electronic control system 50 are connected or connectable by way of a communication link 70, such as a computer bus or by wireless components (Wi-Fi, Bluetooth, etc.).

In aspects, the central processor 52 includes one or more processors, in the case of multiple processors, distributed or parallel processing protocols are utilized. The central processor 52 may include, for example, application specific integrated circuits, a programmable gate array including a field programmable gate array, a graphics processing unit, a physics processing unit, a digital signal processor, or a front-end processor. The central processor 52 is understood to be preprogrammed to execute code or instructions to perform, for example, operations, acts, tasks, functions, or steps, coordinating with other devices and components to perform the operations when needed.

In aspects, the communication module 54 includes a radio communication (cell phone) controller 72, a GPS receiver/transmitter 73, and, optionally, a Wi-Fi controller, or a blue-tooth controller. The communication module 54 also includes one or more antennae 74, a digital signal processor 76, non-transient data storage 78 and a data buffer 80.

In aspects, the propulsion control module 56 includes an accelerator pedal module 82, a propulsion controller 84, and a powertrain control module 86, for controlling the speed of the vehicle 12. The accelerator pedal module 82 is understood to control the speed of the vehicle 12 based on location of the accelerator pedal 102. The propulsion controller 84 includes one or both of a throttle module for controlling throttle valve position and an electronic speed controller including an electronic control circuit that regulates an electric powered motor, depending on how the vehicle is powered. The powertrain control module 86 is configured to adjust transmission gear setting. Based on the position of the accelerator pedal 102, transmission gear selection, and data obtained from a number of sensors including, for example, speed sensors, wheel speed sensors, throttle positions sensors (if present), turbine speed sensors, temperature sensors, etc., the speed and transmission gear selection is adjusted.

The electronic steering module 58 is understood to control the heading, i.e., direction of travel, based on the angle of the steering wheel 100 using a number of sensors 88. In addition, the electronic braking module 60 is understood to control the braking of the vehicle 12 based on driver input, i.e., positioning of the brake pedal 104, as well as input from sensors provided around the vehicle 12, such as those utilized in a collision avoidance module 68, to stop the vehicle 12. In aspects, the collision avoidance module 68 is understood to include a number of sensors 92, such as radar, laser (LIDAR) and camera sensors, to detect objects around the vehicle 12. Then, based on the information gathered by the sensors 92, collision avoidance module 68 provides information to the electronic braking module 60 to stop the vehicle 12.

In aspects, fuel powered or hybrid vehicles further include a fuel injection control module 64 in the electronic control system 50. The fuel injection control module 64 is understood to control the timing and amount of fuel supplied to the engine utilizing information gathered by, e.g., the propulsion control module 56.

In aspects, the vehicle 12 further includes a navigation system 66. The navigation system 66 may be incorporated into an infotainment system, which is configured to provide in-car entertainment and other information to vehicle occupants, including the driver 48. The navigation system 66 is understood to determine the location of the vehicle 12 based on information received by the GPS receiver/transceiver 73, i.e., GPS location data, from global positioning system (GPS) satellites 98, cellular towers 26 providing cellular location data, maps, and sensors including, in aspects, the sensors 92 of the collision avoidance module 68. In aspects, the navigations system 66 includes maps stored in non-transitory data storage 62 or with the service provider 14. Sensors include, for example, those provided in the collision avoidance module 68 or other sensors. In aspects, the navigation system 66 is configured to assess vehicle 12 heading and speed. The navigation system 66 also includes inputs for programming the navigation system 66 and audio/visual outputs for providing directions and other information to the vehicle driver 48.

In aspects, the electronic control system 50 also includes non-transitory data storage 62. The non-transitory data storage 62 is used to store a data such as control logic, software applications, instructions, computer code, data, lookup table, etc., and a transceiver [or input/output ports]. The non-transitory data storage 62 may include computer readable medium, i.e., any type of medium capable of being access by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium excludes wired, wireless, optical, or other communication links that transport transitory electrical or other signals. A non-transitory computer readable medium includes media where data can be permanently stored and media where data can be stored and later overwritten, such as rewritable optical disc or an erasable memory device. Computer code includes any type of program code, including source code, object code and executable code. The central processors 52 is configured to execute the code or instructions.

In aspects, the driver 48 operates the vehicle 12 through the use of a number of driver control interfaces including a steering wheel 100 coupled to the electronic steering module 58, accelerator pedal 102 coupled to the propulsion control module 56 and brake pedal 104 coupled to the electronic braking module 60 to provide inputs into the electronic control system 50. The system 10 overrides the driver 48 when a vehicle slowdown path is received from the service provider 14 and executed by the electronic control system 50. In aspects, when the vehicle slowdown path is received, the vehicle 12 cuts propulsion input from the throttle by way of the propulsion control module 56 and applies the brakes by way of the electronic braking module 60. In aspects, these functions are available in vehicles 12 including advanced-driver assistance systems with adaptive cruise control or braking assistance systems. In further aspects, when the vehicle slowdown path is received, the vehicle cuts propulsion input from the throttle by way of the propulsion control module 56, applies the brakes by way of the electronic braking module 60, and controls the electronic power steering by way of the electronic steering module 58. In aspects, these functions are available in vehicles 12 including advanced-driver assistance systems with adaptive cruise control or braking assistance systems as well as with lane assist or hands-free steering systems.

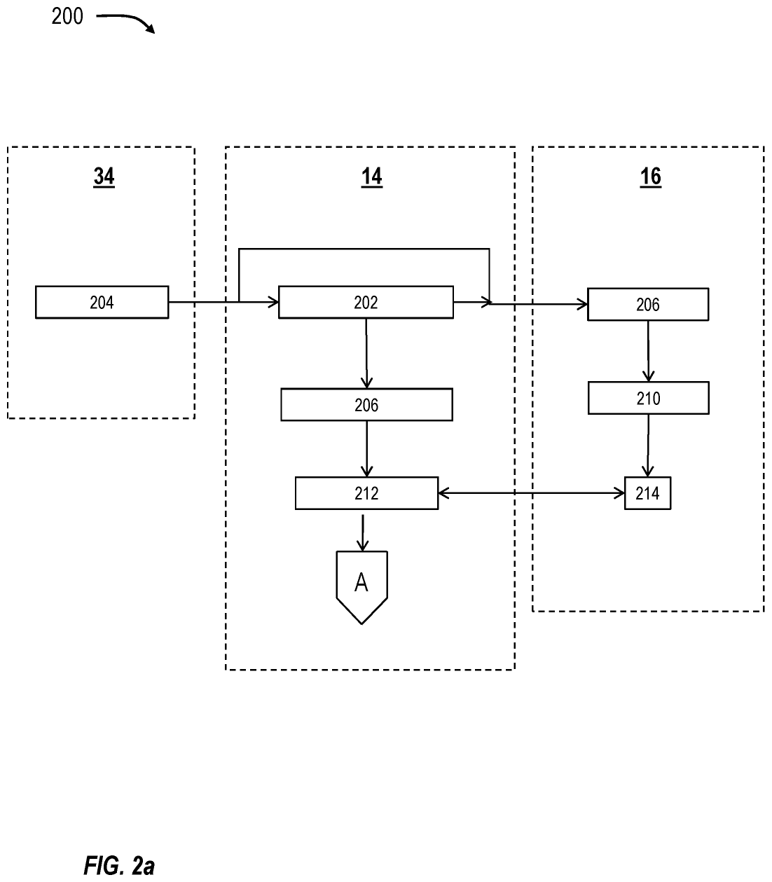

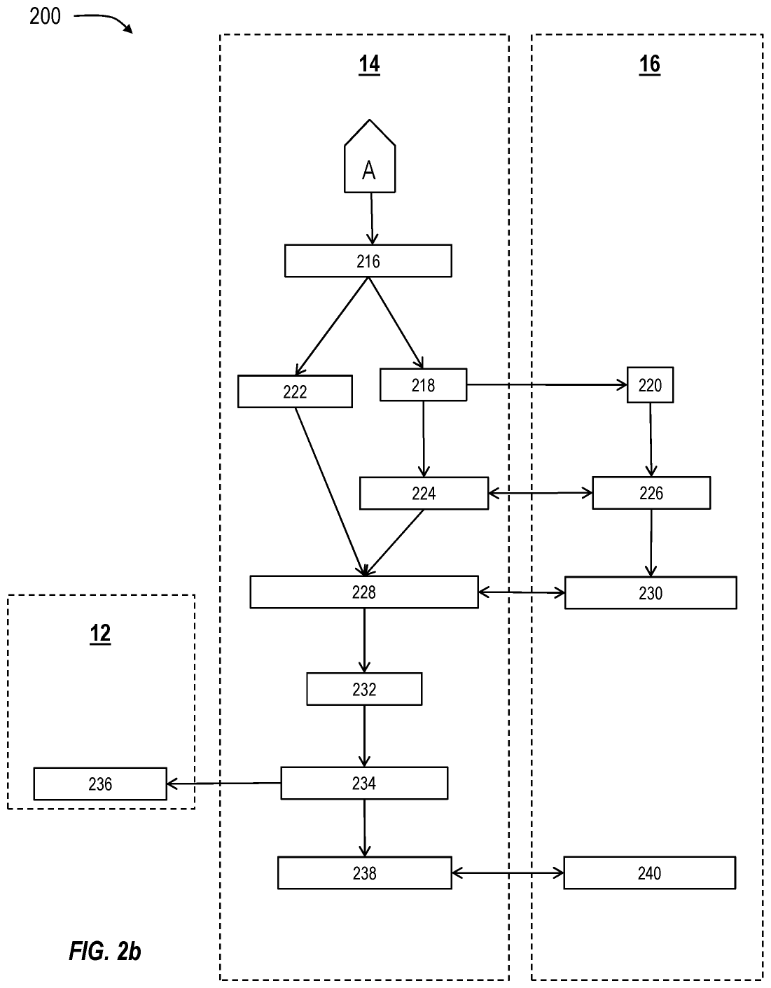

In a number of aspects, the system 10 executes control of the vehicle according to a method 200 illustrated in FIGS. 2a and 2b, with further reference to FIG. 1. In aspects, the method 200 begins in FIG. 2a at block 202 when the service provider 14 receives a stolen vehicle report. In aspects, the stolen vehicle report is initiated by the subscriber 34 at block 204. In further aspects, at block 206 a law enforcement provider 16 also receives a stolen vehicle report initiated by either the subscriber 34 or the service provider 14, with authorization to initiate such a report from the subscriber 34.

At block 208, the service provider 14 initiates an attempt to locate the vehicle 12 using cellular data provided to cellular towers 26 from the communication module 54 or via GPS data provided to GPS satellites 98 from the communication module 54. Once the law enforcement provider 16 is notified of the stolen vehicle 12, at block 210 the law enforcement provider 16 verifies the stolen vehicle report, such as by contacting the subscriber 34 or another owner of the vehicle 12. At block 212, the service provider 14 may query the law enforcement provider 16 as to whether the vehicle is considered stolen or receive from the law enforcement provider 16 verification provided to the service provider 14 at block 214 that the vehicle 12 is considered stolen. The method continues at block “A” on FIG. 2b.

Turning now to FIG. 2b, beginning at block “A” once the vehicle location has been identified at block 216, the law enforcement provider 16 is provided the vehicle location at block 218, which may include additional information such as vehicle heading and speed. This enables the law enforcement provider 16 to pursue the vehicle based on the location information at block 220.

In addition, once the vehicle location has been identified at block 218, a determination is made at block 222 as to whether the vehicle 12 is in, or heading towards, a location where the vehicle 12 is eligible for slowdown control. In aspects, the determination uses maps to take into account whether there is a road shoulder, if the vehicle 12 is near a parking area, or if the vehicle 12 can otherwise be removed from a lane of travel. In further aspects, the determination also takes into account information provided by the collision avoidance module 68, using data gathered from sensors 92, such as radar, LIDAR, camera sensors or a combination thereof, to prevent the vehicle 12 from crashing into objects, people or other vehicles in the area.

At block 224 the service provider 14 then queries the law enforcement provider 16 whether visual contact has been established with the vehicle 12 or the law enforcement provider 16 notifies the service provider 14 at block 226 that visual contact with the vehicle 12 has been established and the service provider 14 receives this notice at block 224. Once visual confirmation is received at block 224, at block 228 the service provider 14 queries whether the location and safety conditions, such as weather and traffic conditions, are safe to execute vehicle slowdown control through a vehicle slowdown path. The service provider 14 may also query additional vehicle description information at block 228 to make sure the law enforcement provider 16 is observing the correct vehicle. At block 230 the law enforcement provider 16 verifies the safety conditions and provides additional vehicle description information, which is received by the service provider 14 at block 228. In aspects, additional vehicle information may include, for example, make or color of the vehicle 12, license plate number, vehicle characteristics such as dents or scratches, or characteristics of the driver 48.

The vehicle slowdown path is generated at block 232 using information provided by data from the various sensors associated with the vehicle (e.g., sensors 88, 92), navigation data including GPS, traffic data, and cellular data, law enforcement provider feedback or instructions, and service provider data. The vehicle slowdown path includes a series of inputs that are utilized by the electronic control system 50 of the vehicle 12, including electronic steering module inputs, electronic braking module inputs, and propulsion control module inputs. Additional inputs from other systems may also be provided/accounted for, such as inputs from the collision avoidance module 68 and navigation system 66. In aspects, the vehicle slowdown path includes slowing the vehicle down and steering the vehicle to a particular location while slowing the vehicle down. In further aspects, the vehicle slowdown path includes bringing the vehicle 12 to a complete stop.

At block 234, the vehicle slowdown path is then sent to the vehicle 12 to execute. In aspects, the slowdown path is forwarded to the electronic control system 50 using the various means of communication discussed above. When the vehicle slowdown path is received at block 236, a plurality of driver inputs received through the various control interfaces including the steering wheel 100 coupled to the electronic steering module 58, accelerator 102 coupled to the propulsion control module 56, and brake pedal 104 coupled to the electronic braking module 60 are overridden, or ignored, and a plurality of vehicle slowdown path inputs are substituted for the plurality of driver inputs. Prior to overriding the driver 48, the driver 48 may receive visual or audio notification that an override will occur.

In aspects, the service provider 14 queries or receives confirmation that the vehicle slowdown path has been realized at block 238, i.e., the vehicle 12 has been guided to and stopped in a given location, and at block 240 the law enforcement provider 16 may verify the vehicle slowdown path has been realized.

While the vehicle slowdown path is illustrated as being generated at block 232 after the safety conditions, location of the vehicle, and vehicle description are received from law enforcement provider 16 at block 228, the vehicle slowdown path may alternatively be generated prior to receiving visual contact of the vehicle by the law enforcement provider 16 at block 224.

Further, if the law enforcement provider 16 indicates that visual contact with the vehicle 12 has been lost, the service provider 14 may periodically query or wait to receive instructions that visual contact has been confirmed returning to block 224 each time visual contact has been lost. In addition, if the law enforcement provider 16 indicates that conditions are not safe for the vehicle 12 to execute a vehicle slowdown path at block 230, the service provider 14 may periodically query or wait to receive instructions that conditions are safe to execute a vehicle slowdown path, returning to block 228.

A method and system for controlling a vehicle to realize the slowdown of a vehicle of the present disclosure offers several advantages. These include the ability to control, not only the speed of the vehicle, but also the heading which the vehicle takes during vehicle slowdown. This offers a degree of flexibility should it be necessary to apprehend and stop a vehicle as the vehicle may be removed from the lane of travel while executing the vehicle slowdown path. In aspects, the system and method allows for the slowdown of a stolen vehicle or a vehicle involved in nefarious activities. The system and method also provides for deterrence from stealing a vehicle.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of controlling a vehicle, comprising:
receiving a report indicating a vehicle is stolen;
determining a vehicle location;
providing the vehicle location to a law enforcement provider;
generating a slowdown path for the vehicle;
querying the law enforcement provider for a confirmation of the vehicle location and an identification of the vehicle;
querying the law enforcement provider if the slowdown path is safe and when to initiate slowdown; and
forwarding the slowdown path to the vehicle.

2. The method of claim 1, further including overriding control of steering, acceleration, and braking by a driver of the vehicle and configuring the vehicle to slowdown in accordance with the slowdown path.

3. The method of claim 2, further comprising slowing the vehicle down in accordance with the vehicle slowdown path.

4. The method of claim 1, further comprising querying the law enforcement provider whether the vehicle is considered stolen prior to determining the vehicle location.

5. The method of claim 4, further comprising receiving a confirmation from law enforcement that the vehicle is considered stolen.

6. The method of claim 1, wherein the vehicle location is determined based on GPS location data.

7. The method of claim 1, wherein querying the law enforcement provider for the confirmation of the vehicle location further includes receiving a notification of visual confirmation of the vehicle location.

8. The method of claim 1, wherein querying the law enforcement provider for the identification of the vehicle further includes receiving a notification of visual confirmation of the identification of the vehicle.

9. The method of claim 1, wherein generating the slowdown path for the vehicle includes using maps and vehicle sensor data.

10. The method of claim 9, wherein generating the slowdown path for the vehicle includes using traffic data.

11. The method of claim 1, further comprising adjusting the slowdown path for the vehicle based on an instruction from the law enforcement provider.

12. The method of claim 1, further comprising querying the law enforcement provider for a verification of vehicle slowdown.

13. The method of claim 1, wherein vehicle slowdown includes stopping the vehicle.

14. The method of claim 1, wherein the reporting of the vehicle being stolen is received from an owner of the vehicle.

15. A method of controlling a vehicle, comprising:
receiving a request to slowdown a vehicle;
determining a vehicle location;
providing the vehicle location to a law enforcement provider;
generating a slowdown path for the vehicle;
receiving a confirmation of the vehicle location and an identification of the vehicle by the law-enforcement provider;
receiving a confirmation of the safety of the slowdown path by the law enforcement provider;
receiving a request from the law enforcement provider for slowdown; and
forwarding the slowdown path to vehicle.

16. The method of claim 15, wherein generating the slowdown path for the vehicle includes determining if the vehicle location is safe to slowdown the vehicle or if the vehicle is approaching a location where it is safe to slowdown the vehicle.

17. The method of claim 15, further comprising forwarding commands overriding control of the vehicle by a driver and controlling the vehicle through the slowdown path.

18. The method of claim 17, wherein generating the slowdown path includes generating slowdown path inputs including acceleration commands, braking commands, and steering commands;
wherein forwarding the slowdown path to the vehicle includes forwarding the slowdown path inputs to the vehicle; and
overriding the driver includes substituting driver inputs received by at least one of the following: an electronic steering module, a propulsion control module, and an electronic braking module with the slowdown path inputs.

19. A system for controlling a vehicle, comprising:
a service provider configured to identify a vehicle location, generate slowdown path inputs to realize a slowdown path, and transmit the slowdown path inputs to a vehicle, wherein the slowdown path inputs includes acceleration commands, braking commands, and steering commands; and
a central processor provided in the vehicle, wherein the central processor is coupled to a communication module, a propulsion control module, an electronic steering module, and an electronic braking module, the central processor configured to
receive the slowdown path inputs from the service provider through the communication module, and
override driver inputs received by at least one of the following: the electronic steering module, the propulsion control module, and the electronic braking module with the slowdown path inputs upon receipt of a command to slowdown the vehicle.

20. The system of claim 19, further comprising a law enforcement provider, wherein the service provider is configured to query the law enforcement provider of at least one of the following:
i) confirmation of the vehicle location;
ii) confirmation of the slowdown path safety; and
iii) confirmation of slowdown path realization.
